(19) United States
(12) Patent Application Publication
(10) Pub. No.: US 2021/0046951 A1
(43) Pub. Date: Feb. 18, 2021

(54) APPARATUS FOR GENERATING ACCELERATION PROFILE AND METHOD FOR AUTONOMOUS DRIVING ON CURVED ROAD USING THE SAME

(71) Applicants: HYUNDAI MOTOR COMPANY, Seoul (KR); KIA MOTORS CORPORATION, Seoul (KR)

(72) Inventor: Hee Gwon KIM, Seoul (KR)

(73) Assignees: HYUNDAI MOTOR COMPANY, Seoul (KR); KIA MOTORS CORPORATION, Seoul (KR)

(21) Appl. No.: 16/864,526

(22) Filed: May 1, 2020

(30) Foreign Application Priority Data
Aug. 16, 2019 (KR) 10-2019-0100312

(51) Int. Cl. B60W 60/00; B62D 15/02; B60W 30/14

(52) U.S. Cl. CPC B60W 60/0011; B60W 60/0016; B60W 30/143; B62D 15/021; B60W 60/0018

(57) ABSTRACT

A method for driving a vehicle on a curved road includes: detecting, by a processor, a curved road which is ahead of a vehicle and has a curvature equal to or greater than a threshold value; calculating, by a processor, a target acceleration to enter into the curved road; generating, by a processor, a driving pattern using a magnitude of the target acceleration; and calculating, by a processor, an acceleration profile based on the driving pattern; outputting, by a processor, a control torque based on the acceleration profile, and controlling the vehicle.

This application claims priority to and the benefit of Korean Patent Application No. 10-2019-0100312, filed on Aug. 16, 2019, the entire contents of which are incorporated herein by reference.

### FIELD

The present disclosure relates to an apparatus for generating an acceleration profile and a method for autonomous driving on a road using the same.

### BACKGROUND

The statements in this section merely provide background information related to the present disclosure and may not constitute prior art.

Currently, a commercially available autonomous vehicle applies an advanced driver assistance system (ADAS) to free a driver from simple operations such as manipulation of a steering wheel and a pedal while the vehicle travels and also to prevent accidents due to carelessness of the driver, and thus has recently attracted more attention.

However, we have discovered that a general ADAS has not yet been combined with a dynamic factor indicating the overall longitudinal and lateral motions of a vehicle and is only limitedly able to quantitatively calculate a control value defined by associating the longitudinal and lateral motions, and thus, the behavior of the vehicle is awkward depending on the road environment. In particular, sudden braking, sudden steering, and sudden acceleration occur when a vehicle travels along a curved road on which the behavior of the vehicle changes according to a flow of deceleration, turning, and deceleration, which acts as a factor for increasing the discomfort of a passenger who rides in the vehicle, as shown in FIGS. 1A and 1B.

FIGS. 1A and 1B are views for explaining discomfort of a passenger when a vehicle travels on a curved road using an ADAS installed in a general autonomous vehicle. FIG. 1A is a view illustrating an acceleration vector of a vehicle that behaves according to a flow of rapid braking, sudden steering, and sudden acceleration when the vehicle travels on a curved road. FIG. 1B is a view that qualitatively represents a state change of a head of a passenger who rides in the vehicle.

Referring to FIGS. 1A and 1B, the trajectory of the acceleration vector \vec{a} is intermittently changed at a time point at which the behavior of the vehicle changes, for example, rapid braking→sudden steering (1) and sudden steering→sudden acceleration (2), and the vehicle moves according to a driving pattern in the form of a cross. As such, when the vehicle moves according to the cross-shaped driving pattern, the vehicle suddenly lurches to the right and left due to centrifugal force, and a user U who rides in the vehicle has difficulty in maintaining a desired body position due to inertial force. In particular, the head of the human body of the user U, which is not confined by a safety device, is irregularly shaken, and thus the discomfort of the passenger is increased.

### SUMMARY

The present disclosure provides an apparatus for generating an acceleration profile and a method for autonomous driving on a curved road using the same for proposing a driving pattern defined by associating motions in the longitudinal and lateral directions while the vehicle travels on a curved road, thereby reducing the discomfort of a passenger.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method for autonomous driving on a curved road includes: detecting, by a processor, a curved road which is ahead of a vehicle and has a curvature equal to or greater than a threshold value; calculating, by a processor, a target acceleration to enter the curved road; generating, by a processor, a driving pattern using a magnitude of the target acceleration; and calculating, by a processor, an acceleration profile based on the driving pattern; outputting, by a processor, a control torque based on the acceleration profile, and controlling the vehicle.

The acceleration profile may include at least one of a longitudinal acceleration, a lateral acceleration, or a steering angle.

The driving pattern may correspond to a trajectory of an acceleration vector defined by associating a lateral acceleration while the vehicle is turning right or left and a longitudinal acceleration while the vehicle is accelerated or decelerated. The driving pattern may include: a turn pattern in which a size of the acceleration vector is maintained constant and a direction of the acceleration vector is changed along a circular trajectory, and an acceleration pattern in which the size and direction of the acceleration vector are changed along an oval trajectory.

The calculating the target acceleration may include comparing a current speed of the vehicle with a speed limit of the curved road.

The controlling the vehicle may include: controlling a deceleration based on the target acceleration during a first section, corresponding to a section between a current position of the vehicle and a point at which the vehicle enters the curved road; controlling turning of the vehicle to reduce a magnitude of a longitudinal acceleration based on the target acceleration during a second section corresponding to a section between the first section and a maximum curvature point of the curved road; and controlling an acceleration of the vehicle based on a maximum acceleration based on properties of the vehicle during a third section corresponding to a section between the second section and a point at which the vehicle leaves the curved road.

In this case, the controlling turning is performed to increase a magnitude of the lateral acceleration in a state in which a sum of the longitudinal acceleration and lateral acceleration is maintained constant.

In another form of the present disclosure, an acceleration profile generating apparatus may include: a road shape recognizer configured to detect a curved road which is ahead of a vehicle and has a curvature equal to or greater than a threshold value; a driving pattern generator configured to calculate a target acceleration to enter the curved road and to generate a driving pattern using a magnitude of the target acceleration; and a vehicle controller configured to calculate an acceleration profile based on the driving pattern, and to output a control torque based on the acceleration profile.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1A and 1B are views for explaining the discomfort of a passenger when a vehicle travels on a curved road using an advanced driver assistance system (ADAS) installed in a general autonomous vehicle;

FIG. 2 is a schematic block diagram of an autonomous driving control apparatus;

FIG. 3 is a view for explaining a control method of driving of a vehicle that travels on a curved road;

FIG. 4 is a view for explaining a method of generating a driving pattern defined by associating longitudinal and lateral motions of a vehicle;

FIGS. 5A and 5B are views for explaining the discomfort of a passenger based on a shape of a driving pattern;

FIG. 6 is a graph for explaining an acceleration profile for driving on a curved road;

FIGS. 7A to 7B are views showing an example of comparison of electromyography (EMG) waves of the sternocleidomastoid muscle of a passenger who rides in a back seat of the vehicle depending on a shape of a driving pattern; and

FIG. 8 is a flowchart for explaining a method for autonomous driving on a curved road.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary form is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute the modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, forms will be described in detail with reference to the attached drawings. The forms may, however, be embodied in many alternate forms and the disclosure should not be construed as limited to the forms set forth herein. Accordingly, while the disclosure is susceptible to various modifications and alternative forms, specific forms thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the forms as defined by the claims.

The terms such as “first” and “second” are used herein merely to describe a variety of constituent elements, but the constituent elements are not limited by the terms. The terms are used only for the purpose of distinguishing one constituent element from another constituent element. In addition, terms defined in consideration of configuration and operation of forms are used only for illustrative purposes and are not intended to limit the scope of the forms.

The terminology used herein is for the purpose of describing particular forms only and is not intended to be limiting of the inventive concept. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an autonomous driving control apparatus according to each form of the present disclosure will be described with reference to the accompanying drawings.

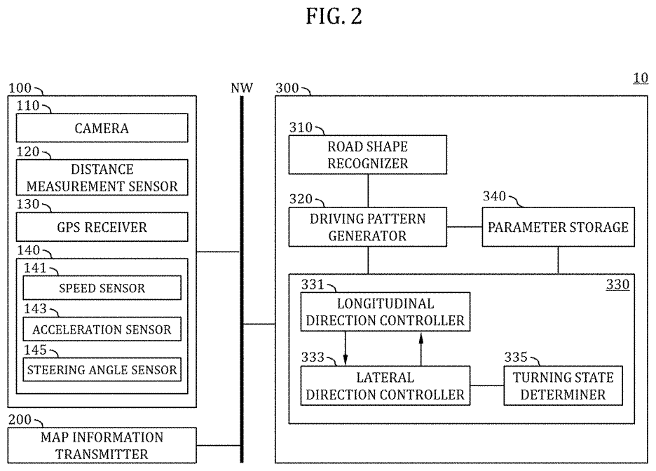

FIG. 2 is a schematic block diagram of an autonomous driving control apparatus according to one form of the present disclosure.

Referring to FIG. 2, an autonomous driving control apparatus 10 may include a sensor information transmitter 100, a map information transmitter 200, and an acceleration profile generating device 300.

The sensor information transmitter 100 may include a camera 110, a distance measurement sensor 120, a global positioning system (GPS) receiver 130, and a vehicle sensor 140.

The camera 110 may acquire information on an image of a region around a vehicle, captured through an optical system, and may perform image processing such as noise removal, image quality and chroma adjustment, or file compression on the acquired image information.

The distance measurement sensor 120 may be embodied as a RADAR for measuring a distance from an object or a relative speed using electromagnetic waves and/or a LIDAR for additionally observing a blind area, which is not recognizable by the RADAR, using light, and may measure a time taken for electromagnetic waves or light emitted to an object to reach the same in order to measure a distance between the vehicle and the object.

The GPS receiver 130 may receive a navigation message from at least one GPS satellite positioned above the Earth and may collect position information of the vehicle.

The vehicle sensor 140 may include a speed sensor 141, an acceleration sensor 143, and a steering angle sensor 145, which collect information about a driving speed, acceleration, a steering angle, and the like of the vehicle, and may periodically measure state information of various actuators.

The map information transmitter 200 may pre-store high definition map information for distinguishing between a road and a lane in the form of a database (DB), and the map information may be automatically updated at a predetermined period via wireless communication, or may be manually updated by a user.

The map information may be configured in units of nodes and links, and may include information on a curvature (or a radius of curvature) of a road and position information of a curved road corresponding to the curvature information. Here, the node may refer to a point at which the properties of the road are changed, and the link may be classified into a node and a path in units of lanes for connecting the nodes.

The sensor information transmitter 100 and the map information transmitter 200 may communicate with the acceleration profile generating device 300 through a vehicular network (NW), and the vehicular network (NW) may include various in-vehicle communications such as a controller area network (CAN), a CAN with flexible data rate (CAN-FD), FlexRay, media oriented systems transport (MOST), or time triggered Ethernet (TT Ethernet).

The acceleration profile generating device 300 may include a road shape recognizer 310, a driving pattern generator 320, a vehicle controller 330, and a parameter storage 340. Here, the terms, such as ‘recognizer’, ‘generator’, or ‘controller’, etc., should be understood as a unit that processes at least one function or operation and that may be embodied in a hardware manner (e.g., one or more processors), a software manner, or a combination of the hardware manner and the software manner.

The road shape recognizer 310 may combine various pieces of information collected through the sensor information transmitter 100 and the map information transmitter 200 and may recognize the shape of the road ahead of the vehicle.

The road shape recognizer 310 may recognize a curved road, which is ahead of the vehicle and has a curvature equal to or greater than a threshold value, based on road curvature information pre-stored in the map information transmitter 200, current vehicle position information received through the GPS receiver 130, surrounding image information analyzed through the camera 110, and the like, and may transmit a command for generating a driving pattern of the recognized curved road to the driving pattern generator 320.

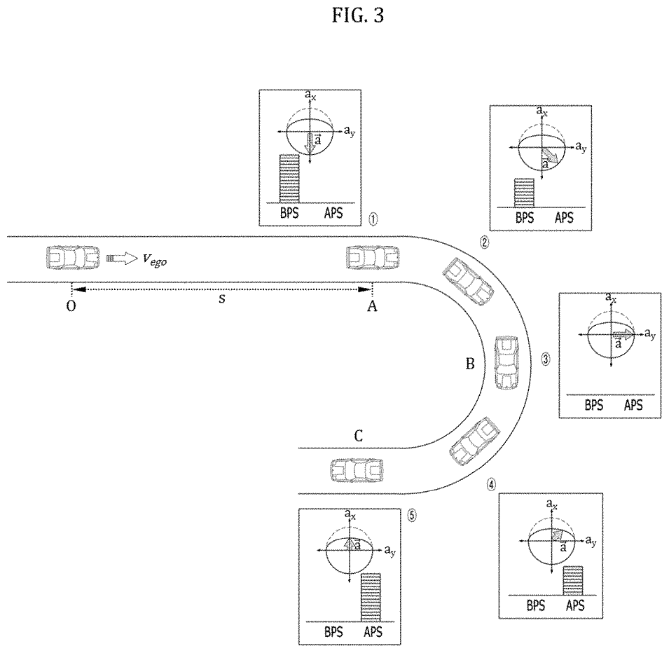

Upon receiving the command from the road shape recognizer 310, the driving pattern generator 320 may calculate a target acceleration Gₜₒₜₐₗ to enter the curved road and may generate a driving pattern having a rounded shape with a magnitude |Gₜₒₜₐₗ| of the target acceleration as a maximum radius r, which will be described below in detail with reference to FIGS. 3 to 5.

FIG. 3 is a view for explaining a control method of driving of a vehicle that travels on a curved road according to one form of the present disclosure.

Referring to FIG. 3, the driving pattern generator 320 may compare a current speed V_{ego} of the vehicle, measured through the speed sensor 141, with a speed limit Vₗᵢₘᵢₜ of the curved road recognized through the road shape recognizer 310 and may calculate the target acceleration Gₜₒₜₐₗ.

The driving pattern generator 320 may calculate the speed limit Vₗᵢₘᵢₜ based on the information on curvature (C) of the curved road, pre-stored in the map information transmitter 200, and dynamics law, as a pre-processing procedure of calculation of the target acceleration Gₜₒₜₐₗ. Here, the speed limit Vₗᵢₘᵢₜ may be changed depending on a coefficient of friction and a degree of curvature of a road corresponding to the maximum speed to enter the curved road.

The driving pattern generator 320 may determine the speed limit Vₗᵢₘᵢₜ in consideration of the radius of curvature (R=1/C) of a road and a centrifugal acceleration aₗᵢₘᵢₜ, and, for example, may be calculated using Equation 1 below. Here, the centrifugal acceleration aₗᵢₘᵢₜ may be a recommended lateral acceleration for preventing a vehicle from leaving a course when the vehicle turns on the curved road, and may be preset in the range of 0.2 to 0.5 G, but the scope of the present disclosure is not limited thereto.

Vₗᵢₘᵢₜ=\sqrt{Raₗᵢₘᵢₜ} [Equation 1]

The driving pattern generator 320 may read a table containing information of the radius of curvature (R) and the speed limit Vₗᵢₘᵢₜ, pre-written in the parameter storage 340 using Equation 1 above, or may determine the speed limit Vₗᵢₘᵢₜ using the legal speed limit for the curved road, as dictated by traffic laws.

The driving pattern generator 320 may calculate the target acceleration Gₜₒₜₐₗ using Equation 2 below when the current speed V_{ego} is greater than the speed limit Vₗᵢₘᵢₜ as a comparison result between the measured current speed V_{ego} of the vehicle and the calculated speed limit Vₗᵢₘᵢₜ of the curved road.

$${G}_{total} = \frac{{V}_{ego}^{2} - {V}_{limit}^{2}}{2 S} \qquad [ Equation 2 ]$$

Here, V_{ego} is the current speed of the vehicle, Vₗᵢₘᵢₜ is the speed limit of a curved road, and S is the distance to an entry point A of the curved road from the current position O of the vehicle.

The driving pattern generator 320 may calculate the target acceleration Gₜₒₜₐₗ based on a vehicle speed when the current speed V_{ego} is equal to or less than the speed limit Vₗᵢₘᵢₜ as a comparison result between the measured current speed V_{ego} of the vehicle and the calculated speed limit Vₗᵢₘᵢₜ of the curved road, in which case the target acceleration Gₜₒₜₐₗ may be determined in consideration of a rate of change in vehicle speed per hour.

When a vehicle travels on the curved road, a behavior of the vehicle may change according to a flow of deceleration (\textcircled{1}), turning (\textcircled{1}→\textcircled{2}→\textcircled{3}), and acceleration (\textcircled{3}→\textcircled{4}→\textcircled{5})), and thus an acceleration vector \vec{a} of the vehicle may also change therewith. In this case, even if a vehicle speed is decelerated within the speed limit Vₗᵢₘᵢₜ to enter the curved road, when the acceleration vector \vec{a} is intermittently changed, the vehicle suddenly lurches to the right and left due to centrifugal force according to the properties of a road having a curvature equal to or greater than a threshold value, and a passenger in the vehicle is not capable of maintaining a desired body position due to inertial force, whereby riding comfort is degraded.

Thus, the driving pattern generator 320 may generate a driving pattern defined by associating longitudinal and lateral motions of the vehicle based on the calculated target acceleration Gₜₒₜₐₗ.

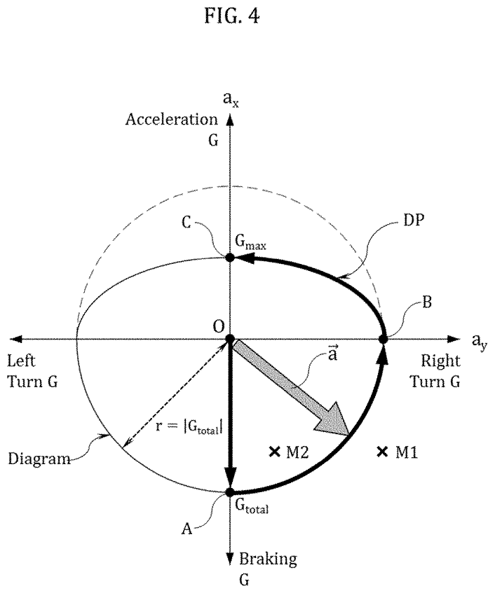

FIG. 4 is a view for explaining a method of generating a driving pattern defined by associating longitudinal and lateral motions of a vehicle according to one form of the present disclosure.

Referring to FIG. 4, the driving pattern generator 320 may draw a diagram having a rounded shape, e.g., a circular and/or oval shape with a magnitude of the target acceleration Gₜₒₜₐₗ measured from a central point O in X-Y coordinates, which is a two-dimensional (2D) space, and may generate a driving pattern DP that follows the diagram in consideration of the turning direction of the vehicle. For example, the diagram shown in the first and fourth quadrants in X-Y coordinates indicates a driving pattern of the vehicle during a right turn, and the diagram shown in the second and third quadrants indicates a driving pattern of the vehicle during a left turn.

The diagram is one element used to represent overall longitudinal and lateral motions of the vehicle that travels on a curved road and may be defined as a boundary line for classifying the behavior of the vehicle into a safe area and a hazardous area. For example, when the vehicle moves outside the range of the boundary line of the diagram (M1), the behavior of the vehicle may fall within the hazardous area, with a high probability that the vehicle will leave the curved road, and when the vehicle is positioned within the range of the boundary line of the diagram (M2), the behavior of the vehicle may fall within the safe area.

Here, the X axis of the diagram is lateral acceleration a_{y} during a right or left turn, the Y axis of the diagram is longitudinal acceleration aₓ during acceleration and deceleration, and acceleration a of the vehicle may be represented by the vector sum of the longitudinal acceleration aₓ and the lateral acceleration a_{y} (\vec{a}=\vec{aₓ}+\vec{a_{y}}).

The driving pattern generator 320 may represent the trajectory of an acceleration vector \vec{a} defined by associating a longitudinal acceleration aₓ and a lateral acceleration a_{y} in X-Y coordinates in the form of a diagram to quantitatively analyze riding comfort of a passenger in the vehicle, and the shape and area of the diagram may be variously adjusted depending on the magnitude of the target acceleration Gₜₒₜₐₗ.

Points A, B, and C on the diagram may indicate states at which the control state of the vehicle changes, point A may be a point at which the vehicle enters a curved road, point B may be a point corresponding to the maximum curvature of the curved road, point C may be a point at which the vehicle leaves the curved road, and the central point O may correspond to the current position of the vehicle.

The driving pattern generator 320 may generate the driving pattern DP including a deceleration pattern corresponding to O-A (hereinafter referred to as a “deceleration section”) of a curved road, a turn pattern corresponding to A-B (hereinafter referred to as a “turn section”), and an acceleration pattern corresponding to B-C (hereinafter referred to as a “acceleration section”), and may transmit the driving pattern DP to the vehicle controller 330.

Upon receiving a command for generating the driving pattern through the road shape recognizer 310, the driving pattern generator 320 may generate the deceleration pattern in which the magnitude of the longitudinal acceleration aₓ follows the target acceleration Gₜₒₜₐₗ with respect to the deceleration section between the central point O and point A having maximum negative acceleration on the Y axis in the longitudinal direction. In this case, the driving pattern generator 320 may determine a point at which the longitudinal acceleration aₓ reaches the target acceleration Gₜₒₜₐₗ as point A.

The driving pattern generator 320 may generate a turn pattern using the relational expression of Equation 3 below with respect to the turn section between point A having a maximum negative acceleration on the Y axis in the longitudinal direction, and point B, having a maximum positive (or negative) acceleration on the X axis in the lateral direction. Here, point B in X-Y coordinates may have the maximum positive or negative acceleration depending on the direction in which the vehicle turns.

aₓ²+a_{y}²=Gₜₒₜₐₗ² [Equation 3]

The acceleration vector \vec{a} of the turn pattern may move along a diagram with a circular shape while a scalar of the acceleration vector a is maintained constant and only the direction thereof is changed, and the scalar of the longitudinal deceleration aₓ may be gradually reduced, and a scalar of the lateral acceleration a_{y} may gradually increase over time. In this case, the driving pattern generator 320 may determine, as point B, a point at which the longitudinal acceleration aₓ has a minimum value (or 0) and the lateral acceleration a_{y} has a maximum value (or the maximum radius r) within the range of the boundary line of the diagram.

The driving pattern generator 320 may generate the acceleration pattern using the relational expression of Equation 4 below with respect to the acceleration section between point B, having a maximum positive (or negative) acceleration on the X axis in the lateral direction, and point C, having a maximum positive acceleration on the Y axis in the longitudinal direction.

$$\frac{{a}_{x}^{2}}{{G}_{total}^{2}} + \frac{{a}_{y}^{2}}{{G}_{max}^{2}} = 1 \qquad [ Equation 4 ]$$

The acceleration vector \vec{a} of the acceleration pattern may move along a diagram with an oval shape while both the scalar and direction of the acceleration vector \vec{a} are changed, in which case Gₘₐₓ is a maximum acceleration based on the properties of the vehicle. Unlike the turn section, in which the vehicle enters the curved road, in the acceleration section, in which the vehicle leaves the curved road, the vehicle is not capable of being accelerated at vehicle power greater than a maximum output range of the vehicle, and when the vehicle is suddenly accelerated in a low stage, wheel slippage, in which a tire slips in position, may occur.

Thus, the maximum acceleration Gₘₐₓ of the acceleration section may be determined based on the magnitude |Gₘₐₓ| of the target acceleration and a safety coefficient a based on the properties of the vehicle (Gₘₐₓ=α|Gₘₐₓ| where a satisfies the range of 0<α<1), and the safety coefficient a may be a value preset by a developer in consideration of the performance limit of an engine installed in the vehicle.

The driving pattern generator 320 may generate the acceleration pattern in which a scalar of the longitudinal acceleration aₓ is gradually increased and a scalar of the lateral acceleration a_{y} is gradually reduced over time, and may determine, as point C, a point at which the lateral acceleration a_{y} has a minimum value (or 0) and the longitudinal acceleration aₓ reaches the maximum acceleration Gₘₐₓ within the range of the boundary line of the diagram.

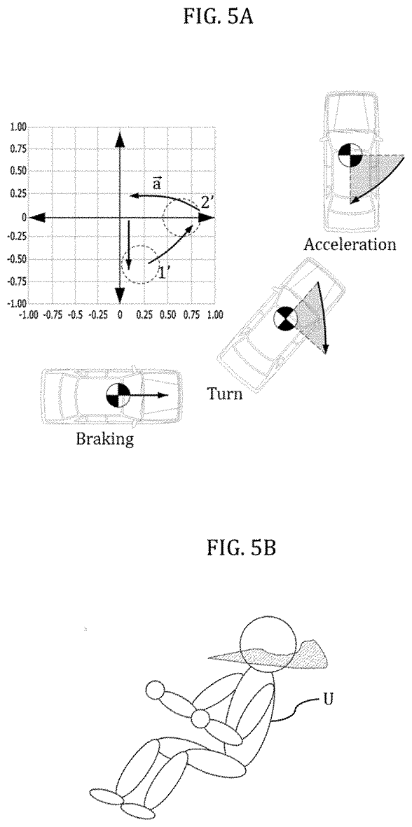

FIGS. 5A and 5B are views for explaining the discomfort of a passenger based on the shape of a driving pattern according to one form of the present disclosure.

FIG. 5A is a view showing a driving pattern of a vehicle that behaves according to the sequence of deceleration, turning, and acceleration when the vehicle travels on a curved road. FIG. 5B is a view that qualitatively represents a state change of a head of a passenger who rides in the vehicle.

Referring to FIGS. 5A and 5B, a trajectory of the acceleration vector a is continuously changed at a time point at which the behavior of the vehicle changes, for example, deceleration→turn (1′), turn→acceleration (2′), and the vehicle moves according to a driving pattern in a rounded shape.

As such, when the vehicle moves according to a driving pattern in a rounded shape, centrifugal force applied to the vehicle and inertial force applied to a user U have approximately the same magnitude and direction, and thus the orientation of the head of the user U may be changed in a regular direction. For example, the head of the user U may move in a circular shape in the same direction as a direction in which the body of the user U moves, and thus passenger discomfort may be reduced and riding comfort may be enhanced.

Referring back to FIG. 2, the vehicle controller 330 may include a longitudinal direction controller 331, a lateral direction controller 333, and a turning state determiner 335.

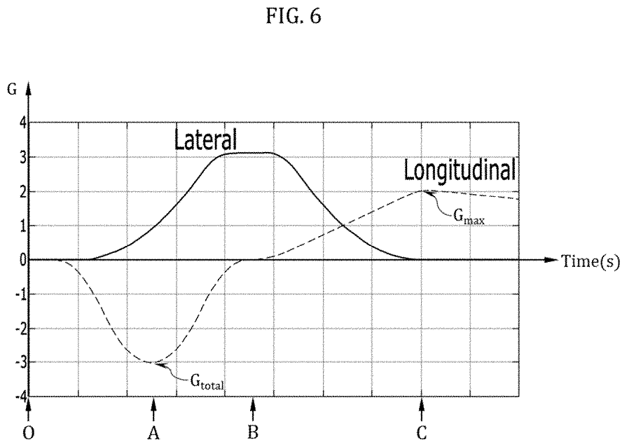

The vehicle controller 330 may receive the driving pattern DP including the deceleration, turning, and acceleration patterns from the driving pattern generator 320, may convert the driving pattern DP into a time-acceleration profile, and may calculate at least one of the longitudinal acceleration aₓ, the lateral acceleration a_{y}, and the steering angle δ in order to quantitatively analyze the behavior of the vehicle, which will be described below in detail with reference to drawings including FIG. 6.

FIG. 6 is a graph for explaining an acceleration profile for driving on a curved road according to one form of the present disclosure.

The vehicle controller 330 may calculate an acceleration profile for each of longitudinal and lateral directions, may output control torque based on the acceleration profile as at least one of an engine device (not shown), a brake device (not shown), or a steering device (not shown), and may control deceleration, turning, and acceleration of the vehicle.

In this case, in the graph shown in FIG. 6, the X axis indicates time and the Y axis indicates acceleration, which may be represented in units of gravitational force (G-force). Based on the X axis, the upper side refers to a behavior of a vehicle in an accelerating state, and the lower side refers to a behavior of a vehicle in a decelerating state.

The longitudinal direction controller 331 and the lateral direction controller 333 may convert the driving pattern DP corresponding to each of the deceleration, turning, and acceleration patterns into an acceleration profile, and may calculate at least one of the longitudinal acceleration aₓ, the lateral acceleration a_{y}, and the steering angle δ, and the vehicle controller 330 may control the vehicle for each of the deceleration, turning, and acceleration sections as described below.

Deceleration Section

The vehicle controller 330 may calculate the longitudinal acceleration aₓ in consideration of the target acceleration Gₜₒₜₐₗ during the deceleration section corresponding to a section between the current position O and the entry point A of the curved road, may output brake torque (e.g., a signal value of a brake pedal sensor (BPS)) corresponding to the longitudinal acceleration aₓ to a brake device (not shown), and may control deceleration of the vehicle (refer to \textcircled{1} of FIG. 3).

The longitudinal direction controller 331 may generate an acceleration profile in which the magnitude of the longitudinal acceleration aₓ gradually increases to follow the target acceleration Gₜₒₜₐₗ based on a linear function (or a nonlinear function) having a negative (−) inclination, and the vehicle controller 330 may perform control to change the state of the vehicle into a turning state from a decelerating state when the rate of change (J=daₓ/dt where daₓ is variation in longitudinal acceleration and dt is variation in time) of longitudinal acceleration reaches 0.

Turn Section

The vehicle controller 330 may calculate the longitudinal acceleration aₓ and the lateral acceleration a_{y} in which the acceleration vector \vec{a} continuously changes in consideration of the magnitude |Gₜₒₜₐₗ| of the target acceleration during the turn section corresponding to a section between the deceleration section and the maximum curvature point B of the curved road, may output brake torque and steering torque corresponding to the longitudinal acceleration aₓ and the lateral acceleration a_{y} to a brake device (not shown) and a steering device (not shown), and may control turning of the vehicle (refer to \textcircled{1}, \textcircled{2}, and \textcircled{3}) of FIG. 3).

The longitudinal direction controller 331 may generate an acceleration profile in which the magnitude of the longitudinal acceleration aₓ gradually decreases until a minimum value (or 0) is reached based on a linear function (or a nonlinear function) having a positive (+) inclination, and may transmit the acceleration profile to the lateral direction controller 333.

The lateral direction controller 333 may calculate the lateral acceleration a_{y} and the steering angle δ using Equation 5 below in consideration of the longitudinal acceleration aₓ received from the longitudinal direction controller 331. The lateral direction controller 333 may generate an acceleration profile in which the magnitude of the lateral acceleration a_{y} increases over time in the state in which the sum of the longitudinal acceleration aₓ and the lateral acceleration a_{y} is maintained constant.

$$( 1 ) {a}_{y} = \sqrt{{G}_{total}^{2} - {a}_{x}^{2}} \\ ( 2 ) δ = 57.3 \frac{L}{R} + {Ka}_{y} \qquad [ Equation 5 ]$$

Here, R is the radius of curvature, L is the wheelbase of a vehicle, K is an understeer gradient, and the sum of the longitudinal acceleration aₓ and the lateral acceleration a_{y} is maintained as a constant value in the turn section. In this case, the constant value may be equal to the magnitude |Gₜₒₜₐₗ| of the target acceleration or the maximum radius r of the driving pattern DP.

The vehicle controller 330 may transition control of the vehicle into an accelerating state from a turning state when the longitudinal acceleration aₓ has a minimum value (or 0) and the lateral acceleration a_{y} reaches a maximum value (or the maximum radius r).

Acceleration Section

The vehicle controller 330 may calculate the longitudinal acceleration aₓ and the lateral acceleration a_{y} in consideration of the maximum acceleration Gₘₐₓ based on the properties of the vehicle during the acceleration section corresponding to a section between the turn section and the departure point C of the curved road, may output driving torque (e.g., a signal value of an accelerator pedal sensor (APS)) and steering torque corresponding to the longitudinal acceleration aₓ and the lateral acceleration a_{y} to an engine device (not shown) and a steering device (not shown), and may control the acceleration of the vehicle (refer to \textcircled{3}, \textcircled{4}, and \textcircled{5} of FIG. 3).

The lateral direction controller 333 may generate an acceleration profile in which the lateral acceleration a_{y} gradually decreases in consideration of restoring force, by which displacement of the steering angle δ returns to a neutral position of a steering wheel, and may transmit the acceleration profile to the longitudinal direction controller 331.

The longitudinal direction controller 331 may calculate the longitudinal acceleration aₓ using Equation 6 below in consideration of the lateral acceleration a_{y} received from the lateral direction controller 333, and may generate an acceleration profile in which the magnitude of the longitudinal acceleration aₓ increases to thus follow the maximum acceleration Gₘₐₓ over time.

$${a}_{x} = \vert {G}_{total} \vert \sqrt{1 - \frac{{a}_{y}^{2}}{{G}_{max}^{2}}} ( where {a}_{x} < \vert {G}_{total} \vert is satisfied ) \qquad [ Equation 6 ]$$

Here, Gₘₐₓ may be the maximum acceleration based on the properties of the vehicle and may be determined based on the magnitude |Gₘₐₓ| of the target acceleration and the safety coefficient α based on the properties of the vehicle, and the safety coefficient α may be a value preset by a developer in consideration of a performance limit on an engine installed in the vehicle.

The vehicle controller 330 may consider that the vehicle leaves the curved road when the steering angle S of the vehicle, measured through the steering angle sensor 145, reaches 0, and may terminate control.

The turning state determiner 335 may periodically compare estimated lateral acceleration calculated by the lateral direction controller 333 with measured lateral acceleration detected through the acceleration sensor 143 and may determine the turning state of the vehicle.

The turning state determiner 335 may compare the difference between the estimated lateral acceleration and the measured lateral acceleration with a preset reference value, and may determine whether the turning state of the vehicle that travels on the curved road is in a normal or abnormal state based on the comparison result.

The turning state determiner 335 may determine that the curved road is in a normal state when the difference between the estimated lateral acceleration and the measured lateral acceleration is less than the reference value, and the turning state determiner 335 may determine that the state of turning on the curved road is abnormal (for example, an over steer state, in which the vehicle is inclined to the internal side of a turning direction, or an understeer state, in which the vehicle deviates away from the turning direction) when the difference is greater than the reference value. When determining that the state of turning on the curved road is abnormal, the turning state determiner 335 may transmit a fail flag to a vehicle dynamic control (VDC) (not shown), and the VDC (not shown) may apply a compensation moment to a brake device (not shown).

The parameter storage 340 may store the target acceleration Gₜₒₜₐₗ and the driving pattern DP, which are calculated and generated by the driving pattern generator 320, and the acceleration profile with respect to the longitudinal and lateral directions, corresponding to the driving pattern DP calculated by the vehicle controller 330. The parameter storage 340 may pre-store the speed limit Vₗᵢₘᵢₜ corresponding to the radius of curvature R in the form of a table. The parameter storage 340 may be embodied as one or more of storages types such as a flash memory, a hard disk, a secure digital (SD) card, a random access memory (RAM), a read only memory (ROM), or web storage.

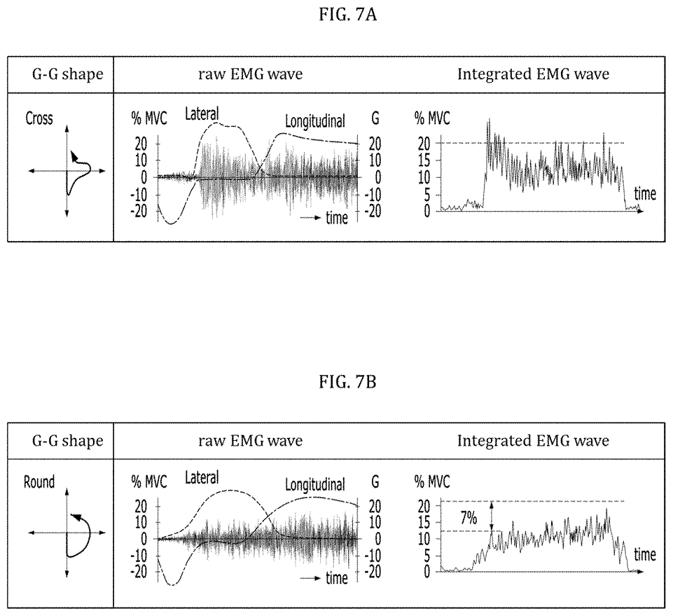

The effect that is obtained when the vehicle is controlled based on the driving pattern according to one form of the present disclosure will be described below with reference to FIGS. 7A and 7B.

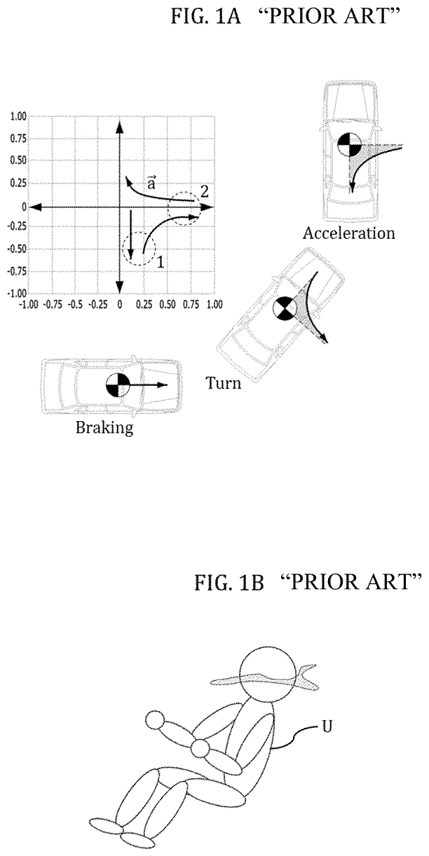

FIGS. 7A to 7B are views showing an example of comparison of electromyography (EMG) waves of the sternocleidomastoid muscle of a passenger who rides in a back seat of the vehicle depending on the shape of a driving pattern. FIG. 7A shows an electromyography (EMG) waveform of the sternocleidomastoid muscle according to the cross-shaped driving pattern shown in FIG. 1. FIG. 7B shows an electromyography (EMG) wave of the sternocleidomastoid muscle according to a driving pattern having the rounded shape shown in FIGS. 5A-5B.

The sternocleidomastoid muscle is a muscle for maintaining the posture of the head in response to inertial force applied to the human body, and the electromyography (EMG) wave of the sternocleidomastoid muscle may be analyzed to qualitatively estimate the discomfort of a passenger. Here, electromyography (EMG) refers to the use of an electrical signal that is generated along the muscle fiber from the surface of the muscle according to motion of the sternocleidomastoid muscle when the muscle is contracted and released.

The raw EMG waves shown in FIGS. 7A and 7B may be used to analyze the activation frequency and response period of the muscle, and an integrated EMG wave may be used to analyze the fatigue and burden of the muscle.

As seen from FIG. 7A, when the vehicle moves according to the cross-shaped driving pattern, the amplitude of the raw EMG wave increases drastically when the vehicle enters the curved road, after which muscular activity may respond to application of lateral acceleration and longitudinal acceleration until the vehicle leaves the curved road. That is, the current state indicates a state in which the muscle has a short activation frequency and a short response period and is repeatedly contracted and released for a short time. It may be seen that, according to the integrated EMG wave, the maximal voluntary contraction (MVC) may be greater than about 20% at a time point at which the vehicle enters the curved road, and the muscle burden of the passenger increases due to rapid braking, sudden steering, and sudden acceleration.

In contrast, referring to FIG. 7B, when the vehicle moves along the driving pattern in the rounded shape, the amplitude of the raw EMG wave may gradually increase from a time point at which the vehicle enters the curved road, and then, stable muscular activity may be maintained with an approximately constant amplitude until the vehicle leaves the curved road. It may be seen that, according to the integrated EMG wave, maximal voluntary contraction (MVC) may decrease by about 7% compared with FIG. 7A at a point when the vehicle enters the curved road. That is, according to one form of the present disclosure, when the vehicle travels on the curved road according to the driving pattern in the rounded shape, the burden on the sternocleidomastoid muscle may decrease, and thus, the discomfort of a passenger who rides in the vehicle may decrease.

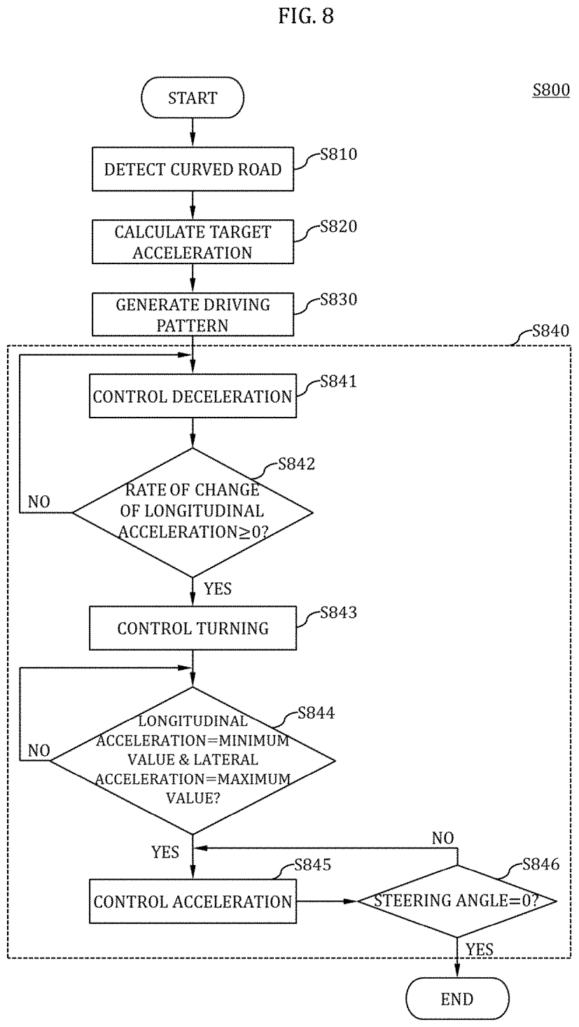

FIG. 8 is a flowchart for explaining a method for autonomous driving on a curved road according to one form of the present disclosure.

Referring to FIG. 8, the method for autonomous driving on a curved road S800 may include a curved road detection operation S810, a target acceleration calculation operation S820, a driving pattern generating operation S830, and a vehicle control operation S840.

First, the road shape recognizer 310 may combine various pieces of information collected through the sensor information transmitter 100 and the map information transmitter 200 and may detect a curved road, which is ahead of the vehicle and has a curvature equal to or greater than a threshold value (S810).

Then, the driving pattern generator 320 may calculate the target acceleration Gₜₒₜₐₗ to enter the detected curved road (S820).

The driving pattern generator 320 may generate the driving pattern DP in the rounded shape in which the magnitude of the target acceleration Gₜₒₜₐₗ is the maximum radius r in X-Y coordinates (S830).

Then, the vehicle controller 330 may convert the driving pattern DP into a time-acceleration profile, and may calculate at least one of the longitudinal acceleration aₓ, the lateral acceleration a_{y}, and the steering angle δ in order to quantitatively analyze a behavior of the vehicle, may output control torque based on the acceleration profile to at least one of an engine device (not shown), a brake device (not shown), or a steering device (not shown), and may control deceleration, turning, and acceleration of the vehicle (S840). Operation S840 will be described in more detail.

The vehicle controller 330 may calculate the longitudinal acceleration aₓ that follows the target acceleration Gₜₒₜₐₗ during the deceleration section corresponding to a section between the current position O and the entry point A of the curved road, may output brake torque corresponding to the longitudinal acceleration aₓ to a brake device (not shown), and may control deceleration of the vehicle (S841).

Then, the vehicle controller 330 may determine whether a rate of change (J=daₓ/dt where daₓ is variation in longitudinal acceleration and dt is variation in time) of longitudinal acceleration reaches 0 and may transition a control state of the vehicle (S842).

When the rate of change J of the longitudinal acceleration is equal to or greater than 0, the control state may change to turning from deceleration (YES of S842), the vehicle controller 330 may calculate the longitudinal acceleration aₓ and the lateral acceleration a_{y} in which the acceleration vector \vec{a} continuously changes in consideration of the magnitude |Gₜₒₜₐₗ| of the target acceleration during the turn section corresponding to a section between the deceleration section and the maximum curvature point B of the curved road, may output brake torque and steering torque corresponding to the longitudinal acceleration aₓ and the lateral acceleration a_{y} to a brake device (not shown) and a steering device (not shown), and may control turn of the vehicle (S843). In this case, the magnitude of the longitudinal acceleration aₓ may gradually decrease, the magnitude of the lateral acceleration a_{y} may gradually increase, and the sum of the longitudinal acceleration aₓ and the lateral acceleration a_{y} may be maintained as a constant value (e.g., the magnitude |Gₜₒₜₐₗ| of the target acceleration or the maximum radius r of the driving pattern DP).

In contrast, when the rate of change J of the longitudinal acceleration is less than 0, deceleration control may be continuously performed (NO of operation S842).

Then, the vehicle controller 330 may determine whether the longitudinal acceleration aₓ has a minimum value (or 0) and the lateral acceleration a_{y} has a maximum value (or a maximum radius r), and may transition a control state of the vehicle (S844).

When the longitudinal acceleration aₓ has a minimum value and the lateral acceleration a_{y} reaches a maximum value, the control state may change from turning to acceleration (YES of operation S844), the vehicle controller 330 may calculate the longitudinal acceleration aₓ and the lateral acceleration a_{y} in consideration of the maximum acceleration Gₘₐₓ based on the properties of the vehicle during the acceleration section corresponding to a section between the turn section and the departure point C of the curved road, may output driving torque and steering torque corresponding to the longitudinal acceleration aₓ and the lateral acceleration a_{y} to an engine device (not shown) and a steering device (not shown), and may control acceleration of the vehicle (S845). In this case, the lateral acceleration a_{y} may be set to gradually decrease in consideration of restoring force by which displacement of the steering angle δ returns to a neutral position of a steering wheel.

In contrast, when the longitudinal acceleration aₓ dose not satisfy a minimum value or the lateral acceleration a_{y} does not reach a maximum value, turn control may be continuously performed (NO of operation S844).

Then, the vehicle controller 330 may determine whether the steering angle δ of the vehicle, measured through the steering angle sensor 145, reaches 0 (S846). When the above condition is satisfied, the vehicle may be considered to leave the curved road and control may be terminated (YES of operation S846), and otherwise, acceleration control may be continuously performed (NO of operation S846).

In accordance with another aspect of the present disclosure, the road shape recognizer 310, the driving pattern generator 320, and the vehicle controller 330 may refer to a hardware device that includes one or more processors to execute instructions to perform all or part of the steps in the above described methods. The instructions executed by the one or more processors may include detecting a curved road, which is ahead of a vehicle and has a curvature equal to or greater than a threshold value; calculating target acceleration to enter the curved road; generating a driving pattern using a magnitude of the target acceleration; and calculating an acceleration profile based on the driving pattern, outputting control torque based on the acceleration profile, and controlling the vehicle.

According to at least one form of the present disclosure, a driving pattern defined by associating motions in the longitudinal and lateral directions may be proposed to quantitatively analyze qualitative the discomfort of a passenger, and deceleration, turning, and acceleration of the vehicle may be controlled based on the analysis result, and thus user-friendly autonomous driving may be enabled in consideration of the road environment. Thus, a sense of unfamiliarity between a vehicle driving behavior and what is expected by a passenger may be reduced, and the discomfort of the passenger may be effectively reduced.

It will be appreciated by persons skilled in the art that that the effects that could be achieved with the present disclosure are not limited to what has been particularly described hereinabove and other advantages of the present disclosure will be more clearly understood from the detailed description.

The method for autonomous driving on a curved road according to an exemplary form described above may be programmed to be executed in a computer and may be stored on a non-transitory computer readable recording medium. Examples of the non-transitory computer readable recording medium include read-only memory (ROM), random-access memory (RAM), CD-ROMs, magnetic tapes, floppy disks, optical data storage devices, etc.

The non-transitory computer readable recording medium may also be distributed over network coupled computer systems so that the computer readable code is stored and executed in a distributed fashion. Also, functional programs, code, and code segments for accomplishing the present disclosure may be easily construed by programmers skilled in the art to which the present disclosure pertains.

Although only several forms have been described above, various other forms are possible. The technical ideas of the forms described above may be combined into various forms unless they are incompatible techniques, and thereby new forms may be realized.

Those skilled in the art will appreciate that the present disclosure may be carried out in other specific ways than those set forth herein without departing from the spirit and essential characteristics of the present disclosure. The above forms are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A method for autonomous driving on a curved road, the method comprising:
detecting, by a processor, a curved road which is ahead of a vehicle and has a curvature equal to or greater than a threshold value;
calculating, by a processor, a target acceleration to enter the curved road;
generating, by a processor, a driving pattern using a magnitude of the target acceleration; and
calculating, by a processor, an acceleration profile based on the driving pattern; and
outputting, by a processor, a control torque based on the acceleration profile, and controlling the vehicle.

2. The method of claim 1, wherein the acceleration profile includes at least one of a longitudinal acceleration, a lateral acceleration, or a steering angle.

3. The method of claim 1, wherein the driving pattern corresponds to a trajectory of an acceleration vector defined by associating a lateral acceleration while the vehicle is turning right or left and a longitudinal acceleration while the vehicle is accelerated or decelerated.

4. The method of claim 3, wherein the driving pattern includes:
a turn pattern in which a size of the acceleration vector is maintained constant and a direction of the acceleration vector is changed along a circular trajectory; and
an acceleration pattern in which the size and direction of the acceleration vector are changed along an oval trajectory.

5. The method of claim 1, wherein calculating the target acceleration includes comparing a current speed of the vehicle with a speed limit of the curved road.

6. The method of claim 1, wherein controlling the vehicle includes: controlling a deceleration based on the target acceleration during a first section corresponding to a section between a current position of the vehicle and a point at which the vehicle enters the curved road.

7. The method of claim 6, wherein controlling the vehicle includes: controlling turning of the vehicle to reduce a magnitude of a longitudinal acceleration based on the target acceleration during a second section corresponding to a section between the first section and a maximum curvature point of the curved road.

8. The method of claim 7, wherein controlling the vehicle includes: controlling an acceleration of the vehicle based on a maximum acceleration based on properties of the vehicle during a third section corresponding to a section between the second section and a point at which the vehicle leaves the curved road.

9. The method of claim 7, wherein controlling turning is performed to increase a magnitude of a lateral acceleration in a state in which a sum of the longitudinal acceleration and lateral acceleration is maintained constant.

10. A computer readable recording medium configured to store an application program executed by a processor to perform the method of claim 1.

11. An acceleration profile generating apparatus comprising:
a road shape recognizer configured to detect a curved road which is ahead of a vehicle and has a curvature equal to or greater than a threshold value;
a driving pattern generator configured to calculate a target acceleration to enter the curved road and to generate a driving pattern using a magnitude of the target acceleration; and
a vehicle controller configured to calculate an acceleration profile based on the driving pattern, and to output a control torque based on the acceleration profile.

12. The acceleration profile generating apparatus of claim 11, wherein the acceleration profile includes at least one of a longitudinal acceleration, a lateral acceleration, or a steering angle.

13. The acceleration profile generating apparatus of claim 11, wherein the driving pattern corresponds to a trajectory of an acceleration vector defined by associating a lateral acceleration during the vehicle is turning right or left and a longitudinal acceleration during the vehicle is accelerated or decelerated.

14. The acceleration profile generating apparatus of claim 13, wherein the driving pattern includes:
a turn pattern in which a size of the acceleration vector is maintained constant and a direction of the acceleration vector is changed along a circular trajectory; and
an acceleration pattern in which the size of the acceleration vector and the direction of the acceleration vector are changed along an oval trajectory.

15. The acceleration profile generating apparatus of claim 11, wherein the target acceleration is determined by comparing a current speed of the vehicle with a speed limit of the curved road.

16. The acceleration profile generating apparatus of claim 11, wherein the vehicle controller is configured to control a deceleration of the vehicle based on the target acceleration during a first section corresponding to a section between a current position of the vehicle and a point at which the vehicle enters the curved road.

17. The acceleration profile generating apparatus of claim 16, wherein the vehicle controller is configured to control turning of the vehicle to reduce a magnitude of a longitudinal acceleration based on the target acceleration during a second section corresponding to a section between the first section and a maximum curvature point of the curved road.

18. The acceleration profile generating apparatus of claim 17, wherein the vehicle controller is configured to control an acceleration of the vehicle based on a maximum acceleration based on properties of the vehicle during a third section corresponding to a section between the second section and a point at which the vehicle leaves the curved road.

19. The acceleration profile generating apparatus of claim 17, wherein the vehicle controller is configured to control turning of the vehicle to increase a magnitude of a lateral acceleration in a state in which a sum of the longitudinal acceleration and lateral acceleration is maintained constant.
